(19) United States
(12) Patent Application Publication
(10) Pub. No.: US 2012/0082892 A1
(43) Pub. Date: Apr. 5, 2012

(54) LITHIUM SECONDARY BATTERY

(75) Inventors: Kei Kobayashi, Kobe-shi (JP); Atsushi Fukui, Kobe-shi (JP); Taizou Sunano, Kobe-shi (JP); Maruo Kamino, Kobe-shi (JP)

(73) Assignee: SANYO ELECTRIC CO., LTD., Osaka (JP)

(21) Appl. No.: 13/242,514

(22) Filed: Sep. 23, 2011

(30) Foreign Application Priority Data
Sep. 30, 2010 (JP) 2010-220325

(51) Int. Cl. H01M 10/052

(52) U.S. Cl. 429/211

(57) ABSTRACT

A lithium secondary battery has a positive electrode, a separator, and a negative electrode having a negative electrode current collector and a negative electrode mixture layer formed on a surface of the negative electrode current collector. The negative electrode mixture layer contains a negative electrode active material including a metal element capable of alloying with lithium. The negative electrode current collector includes a substrate made of a Cu—Fe—P alloy foil, and a surface layer provided on both surfaces of the substrate and made of pure copper. The surface layer has a Vickers hardness of 120 and less than that of the substrate. The negative electrode current collector has a proof stress of 308 MPa.

### BACKGROUND OF THE INVENTION

1. Field of the Invention

The present application relates to lithium-ion secondary batteries.

2. Description of Related Art

In recent years, the power consumption of mobile devices, such as mobile telephones, notebook computers, and PDAs (Personal Digital Assistants) has been increasing rapidly. Accordingly, demand has been increasing for higher capacity lithium-ion secondary batteries. However, when a graphite material, which has conventionally been used widely, is used as the negative electrode active material, it is difficult to increase the capacity of the lithium-ion secondary battery sufficiently. For this reason, much research has been conducted on the negative electrode active material that can achieve higher capacity than the graphite material.

Representative examples of the new negative electrode active materials currently proposed include the materials that can form an alloy with lithium, such as silicon, germanium, and tin. Among them, silicon and silicon alloys have attracted particular attention as a negative electrode active material that is capable of achieving high capacity because silicon shows a high theoretical capacity, about 4000 mAh per 1 g (see, for example, Japanese Published Unexamined Patent Application No. 2008-243661).

However, the negative electrode active material capable of alloying with lithium, such as silicon, shows a large volume change in association with lithium insertion and deinsertion. For this reason, when a battery using the negative electrode active material capable of alloying with lithium is charged and discharged, stress occurs between the negative electrode active material and the negative electrode current collector because of the volume change of the negative electrode active material. As a consequence, the negative electrode active material peels off from the negative electrode current collector, and the charge-discharge capacity degrades as the charge-discharge cycle proceeds. On the other hand, when the battery is configured so as to prevent the negative electrode active material from peeling from the negative electrode current collector, the stress associated with the volume change of the negative electrode active material causes deformation such as bending, creases, or warpage in the negative electrode. As a consequence, misalignment of the wound electrode assembly and damages to the separators occur, causing short circuiting between the positive electrode and the negative electrode.

In view of the problems, for example, it has been proposed to use a copper alloy foil having a tensile strength of 400 N/mm² or higher and a surface roughness Ra of from 0.01 μm to 1 μm as the negative electrode current collector (see, for example, Japanese Published Unexamined Patent Application No. 2003-007305). The publication describes that the use of a negative electrode current collector having a tensile strength of 400 N/mm² or higher can inhibit deformation of the negative electrode, and the use of a negative electrode current collector having a surface roughness Ra of from 0.01 μm to 1 μm can inhibit the negative electrode active material from peeling off from the negative electrode current collector.

It has also been proposed to use a negative electrode current collector having a tensile strength of from 150 N/mm² to 400 N/mm² and a Vickers hardness of from 100 HV to 300 HV (see Japanese Published Unexamined Patent Application No. 2003-086186).

However, even when using a negative electrode current collector having a surface roughness Ra of from 0.01 μm to 1 μm as described in Japanese Published Unexamined Patent Application No. 2003-007305, the peeling of the negative electrode active material cannot be prevented sufficiently. The reason is that when the negative electrode current collector has surface irregularities, the negative electrode active material makes contact with the negative electrode current collector only at the protruding portions in the negative electrode current collector, so the contact area between the negative electrode active material and the negative electrode current collector cannot be ensured sufficiently.

In addition, in the proposal described in Japanese Published Unexamined Patent Application No. 2003-086186, the negative electrode current collector is formed of a metal foil such as a copper (Cu) foil or a nickel foil, or an alloy foil such as a copper alloy foil, a nickel alloy foil, or a stainless steel foil (in other words, the negative electrode current collector is formed of a single material). However, each material has its own tensile strength value and Vickers hardness value unique to the material, and the correlation between the tensile strength and the Vickers hardness is very high. (Specifically, when the tensile strength is higher, the Vickers hardness is accordingly higher). Therefore, the tensile strength and the Vickers hardness of the negative electrode current collector cannot be selected freely. Thus, the problems with the technique disclosed in the above-described publication have been, for example, that the peeling of the negative electrode active material cannot be prevented sufficiently and that the deformation of the negative electrode cannot be inhibited sufficiently.

The present invention provides a lithium secondary battery comprising: a positive electrode, a separator, and a negative electrode having a negative electrode current collector and a negative electrode mixture layer formed on the negative electrode current collector, the negative electrode mixture layer containing a negative electrode active material comprising a metal element capable of alloying with lithium, wherein: the negative electrode current collector comprises a foil substrate and a surface layer provided on at least one surface of both surfaces of the substrate on which the negative electrode mixture layer is formed; the surface layer has a Vickers hardness of 120 or less and less than that of the substrate; and the negative electrode current collector has a proof stress of 300 MPa or greater.

The present invention provides a lithium-ion secondary battery using a negative electrode active material capable of alloying with lithium, in which the proof stress and the Vickers hardness of the negative electrode current collector can be adjusted freely, so that deformation of the negative electrode can be inhibited and at the same time the peeling of the negative electrode active material can be inhibited.

### BRIEF DESCRIPTION OF THE DRAWING

FIG. 1 is a graph illustrating the relationship between Vickers hardness and proof stress.

### DETAILED DESCRIPTION OF THE INVENTION

A lithium secondary battery according to the present invention comprises a positive electrode, a separator, and a negative electrode having a negative electrode current collector and a negative electrode mixture layer formed on the negative electrode current collector. The negative electrode mixture layer contains a negative electrode active material comprising a metal element capable of alloying with lithium. The negative electrode current collector comprises a foil substrate and a surface layer provided on, of both surfaces of the substrate, at least one surface on which the negative electrode mixture layer is formed. The surface layer has a Vickers hardness of 120 or less and less than the Vickers hardness of the substrate. The negative electrode current collector has a proof stress of 300 MPa or greater.

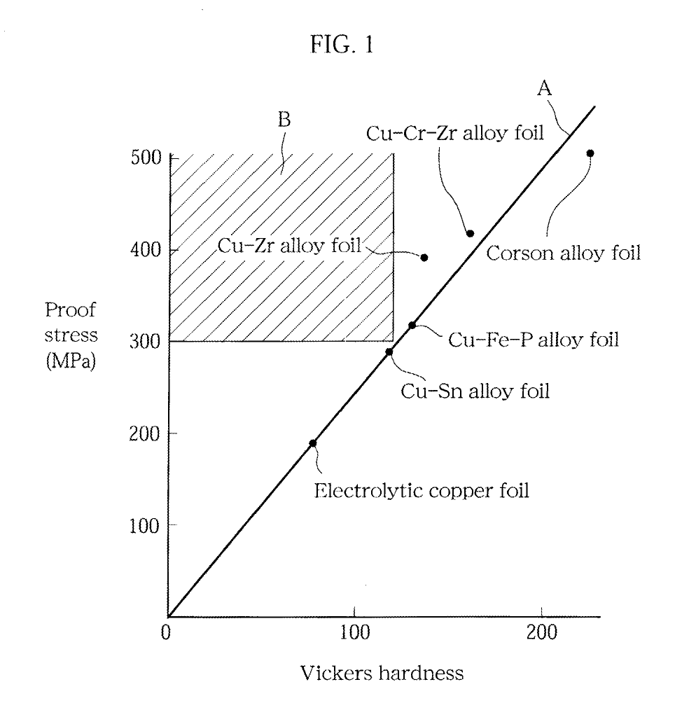

As described above, each material has its own proof stress (tensile strength) value and Vickers hardness value unique to the material, and the correlation between them is very high. (Specifically, when the proof stress is higher, the Vickers hardness is accordingly higher). More specifically, when the material of the negative electrode current collector is varied, the proof stress and the Vickers hardness are limited so as to be on the line A in FIG. 1 or in the vicinity thereof, and they cannot be designed so as to deviate greatly from the line A. Thus, the proof stress and the Vickers hardness of the negative electrode current collector cannot be selected freely.

In view of the problem, the negative electrode current collector is configured to include a substrate and a surface layer so that the proof stress can be adjusted by the substrate while the Vickers hardness can be adjusted by the surface layer, as described above. This configuration makes it possible to freely set the proof stress and the Vickers hardness. (More specifically, the proof stress and the Vickers hardness can be set freely within the range indicated by the region B in FIG. 1 [i.e., within the range in which deformation of the negative electrode can be inhibited and at the same time the peeling of the negative electrode active material can be inhibited].) When the proof stress and the Vickers hardness can be set freely in this way, the negative electrode current collector can be fabricated according to, for example, the type of the negative electrode active material and the pressure during the pressure-rolling in preparing the negative electrode. Therefore, the advantageous effect of inhibiting the peeling of the negative electrode active material and simultaneously inhibiting deformation of the negative electrode can be obtained sufficiently.

The reason why the Vickers hardness of the surface layer is restricted to 120 or less is as follows. When the Vickers hardness is 120 or less, the surface shape of the negative electrode current collector easily deforms into the shape of the negative electrode active material particles. Therefore, when pressing the negative electrode current collector after coating the negative electrode active material thereon, the surface of the negative electrode current collector deforms along the shape of the negative electrode active material, thereby increasing the contact area between the negative electrode current collector and the negative electrode active material. As a result, even if stress occurs because of the volume change of the negative electrode active material in association with charging and discharging, the negative electrode active material can be prevented from peeling from the negative electrode current collector.

The reason why the proof stress of the negative electrode current collector is restricted to 300 MPa or greater is as follows. When the proof stress is 300 MPa or greater, the deformation of the negative electrode current collector such as bending and creases can be prevented, and as a result, short circuiting in the battery can be prevented, even if stress occurs because of the volume change of the negative electrode active material in association with charging and discharging. In the present specification, the term “proof stress” refers to σ_{ε} (1%) determined by the total elongation method according to JIS Z 2241.

The Vickers hardness of the surface layer is set less than the Vickers hardness of the substrate for the following reason. As described above, when the proof stress is greater, the Vickers hardness is accordingly greater. Therefore, if the Vickers hardness of the substrate, which is for maintaining the proof stress, becomes less than the Vickers hardness of the surface layer, which does not affect the proof stress, the proof stress of the negative electrode current collector cannot be restricted to 300 MPa or greater. In other words, the requirement of the surface layer having a Vickers hardness less than the Vickers hardness of the substrate indicates more clearly that the proof stress is adjusted by the substrate.

It is desirable that the substrate of the negative electrode current collector comprise a copper alloy, and the surface layer of the negative electrode current collector comprise pure copper.

The copper alloy in which another metal is added to pure copper shows a greater proof stress and a higher Vickers hardness than pure copper. Therefore, when a copper alloy, having a high proof stress, is used as the substrate of the negative electrode current collector and at the same time pure copper, having a low Vickers hardness, is used as the surface layer, it becomes easy to restrict the Vickers hardness of the surface layer to 120 or less and at the same time restrict the proof stress of the negative electrode current collector to 300 MPa or greater. Since both copper and the copper alloy have high electrical conductivity, they can exhibit the fundamental functions as the negative electrode current collector sufficiently.

It is desirable that the surface layer of the negative electrode active material have a voidage of 30% or greater.

The greater the voidage is, the greater the voids in the material and the greater the surface irregularities of the material. For this reason, when the voidage is greater, the Vickers hardness tends to be less even with the same element. Thus, when the voidage is set to 30% or greater, the Vickers hardness can be easily lowered.

In the present specification, the term “voidage” refers to the proportion of voids in the material with respect to the maximum thickness of the material. More specifically, the voidage can be determined by the following equation (1).

Voidage=(Weight of the surface layer per unit area)/{(Thickness of the surface layer determined by a micrometer)×(Density of the material for the surface layer)} (1)

It is desirable that the surface layer of the negative electrode current collector have a Mohs hardness lower than that of the negative electrode active material.

The reason is that when the Mohs hardness of the surface layer of the negative electrode current collector is higher than that of the negative electrode active material, the negative electrode active material particles may cause breakage such as fractures or pulverization in pressing the negative electrode current collector after coating the negative electrode active material.

When this is taken into consideration, it is preferable that the negative electrode active material has a Mohs hardness of 7 or higher. This configuration makes it possible to deform the surface shape of the negative electrode current collector along the shape of the negative electrode active material particles easily without causing fractures or pulverization of the negative electrode active material particles when pressing the negative electrode. Moreover, it becomes possible to select the material for the surface layer from various materials.

It is desirable that the negative electrode active material contain silicon as its main component.

Silicon shows a high theoretical capacity, and moreover, silicon has a Mohs hardness, of 7. It should be noted that the phrase “the silicon negative electrode active material contains silicon as its main component” means that the negative electrode active material contains silicon in an amount of 50 atomic % or greater.

Hereinbelow, the present invention is described in further detail. It should be construed, however, that the present invention is not limited to the following preferred embodiments but various changes and modifications are possible without departing from the scope of the invention.

### Preparation of Negative Electrode

First, the negative electrode active material was prepared in the following manner. A silicon seed placed in a reducing furnace was heated to 800° C. by passing electric current therethrough. Thereafter, by supplying a mixed gas of high-purity monosilane (SiH₄) gas and hydrogen gas into the reducing furnace, polycrystalline silicon was deposited on the surface of the silicon seed, to thereby prepare a polycrystalline silicon ingot. Then, the polycrystalline silicon ingot was pulverized and classified, to prepare polycrystalline silicon particles (purity: 99%) that serves as the negative electrode active material.

The polycrystalline silicon particles had a crystallite size of 32 nm. The polycrystalline silicon particles had an average particle size of 10 μm. The half-width of the peak of the (111) plane of the silicon was determined by a powder X-ray diffraction analysis, and the crystallite size was determined using Scherrer's formula. The average particle size of the silicon particles was determined by a laser diffraction analysis.

Next, the just-described negative electrode active material, graphite powder (average particle size: 3.5 μm) as a conductive agent, and varnish as a binder were mixed at a mass ratio of 100:3:8.6, and the mixture was added to a dispersion medium N-methyl-2-pyrrolidone and further mixed. Thereby, a negative electrode mixture slurry was prepared. The varnish was a precursor of a thermoplastic polyimide resin, and had the molecular structure represented by the following Chemical Formula I (glass transition temperature: about 300° C., weight-average molecular weight: about 50000).

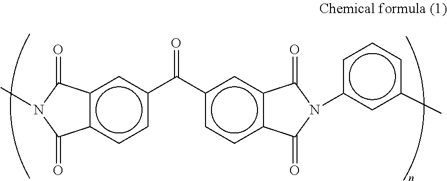

The negative electrode current collector was prepared in parallel with the preparation of the negative electrode mixture slurry. First, a Cu—Fe—P alloy foil (thickness: 18 μm) was prepared as the substrate. Thereafter, a surface layer comprising pure copper was formed on each side of the substrate using electrolytic copper plating. The thickness of the surface layer (thickness per one side) was 1.0 μm, and the voidage of the surface layer was 30%. The thickness of the surface layer was determined from the difference obtained before and after the plating using a micrometer. The voidage of the surface layer was determined from the foregoing equation (1).

Next, the above-described negative electrode mixture slurry was applied onto both sides of the negative electrode current collector in an air atmosphere at 25° C., and then dried in an air atmosphere at 120° C. Thereafter, the resultant material was pressed in an air atmosphere at 25° C., and further subjected to a heat treatment for 10 hours in an argon atmosphere at 400° C. The linear pressure in the pressing was 1 tonf/cm. Thereafter, the resultant structure was cut out into a strip shape with a width of 35.7 mm, and a negative electrode current collector tab made of nickel was attached thereto, whereby a negative electrode was completed.

### Preparation of Positive Electrode

First, Li₂CO₃ and CoCO₃ were mixed in a mortar so that the mole ratio of Li and Co became 1:1. Thereafter, the mixture was sintered in an air atmosphere at 800° C. for 24 hours and then pulverized to obtain powder of lithium cobalt oxide (LiCoO₂). The lithium cobalt oxide powder had an average particle size of 11 μm. The lithium cobalt oxide powder had a BET specific surface area of 0.37 m²/g.

Next, the just-described positive electrode active material, carbon material powder (average particle size: 2 μm) as a conductive agent, and polyvinylidene fluoride as a binder were mixed at a mass ratio of 95:2.5:2.5, and added to N-methyl-2-pyrrolidone as a dispersion medium. Thereafter, the mixture was kneaded, to prepare a positive electrode mixture slurry. Subsequently, the resultant positive electrode mixture slurry was applied onto both sides of a positive electrode current collector (thickness 15 μm) made of an aluminum foil and then dried. Thereafter, the resultant article was pressed. Thereafter, the resultant component was cut out into a strip shape with a width of 33.7 mm, and a positive electrode current collector tab made of aluminum was attached thereto, whereby a positive electrode was completed.

### Preparation of Non-Aqueous Electrolyte Solution

First, lithium hexafluorophosphate (LiPF₆) was dissolved at a concentration of 1.0 mol/L into a mixed solvent of 2:8 volume ratio of 4-fluoroethylene carbonate (FEC) and ethyl methyl carbonate (EMC). Thereafter, 0.4 mass % of carbon dioxide gas was dissolved in the just-described solution, whereby a non-aqueous electrolyte solution was prepared.

### Preparation of Battery

The above-described positive and negative electrodes were opposed to each other across separators interposed therebetween, and they were spirally wound around a winding core having an outer diameter of 4 mm. Then, the winding core was removed, whereby a spirally-wound electrode assembly was prepared. A lithium-ion permeable microporous polyethylene film (thickness: 20 μm) was used as the separator.

Next, the spirally-wound electrode assembly was accommodated in a cylindrical battery can, and the positive electrode current collector tab provided on the positive electrode was connected to a positive electrode external terminal of a positive electrode cap, while the negative electrode current collector tab provided on the negative electrode was connected to the battery can. Thereafter, the above-described non-aqueous electrolyte solution was filled in the battery can, and the battery can and the positive electrode cap were joined to each other with an insulative packing interposed therebetween. Thus, a cylindrical lithium-ion secondary battery was prepared.

The just-described lithium-ion secondary battery had a diameter of 12.8 mm and a height of 37.7 mm. In assembling the battery, the design capacity of the battery was set at 900 mAh with reference to an end-of-charge voltage of 4.2 V.

### EXAMPLES

### Preliminary Experiment

The Vickers hardness and the proof stress were determined for the materials that may be used as the negative electrode current collector. The results are shown in Table 1 and FIG. 1.

TABLE 1

| | | Proof stress |
|---|---|---|
| Material | Vickers hardness | (MPa) |
| Electrolytic copper foil | 88 | 185 |
| Cu—Sn alloy foil | 117 | 285 |
| Cu—Fe—P alloy foil | 127 | 308 |
| Cu—Zr alloy foil | 133 | 385 |
| Cu—Cr—Zr alloy foil | 160 | 414 |
| Corson alloy foil | 226 | 494 |

The values of the Vickers hardness and the proof stress are unique to the materials. Moreover, as clearly seen from Table 1 and FIG. 1, the Vickers hardness and the proof stress are substantially in a proportional relationship to each other (the higher the Vickers hardness is, the greater the proof stress). Accordingly, when the negative electrode current collector is made of a single material, the Vickers hardness and the proof stress fall on the line A in FIG. 1 or in the vicinity of the line A, and they cannot be designed so as to deviate greatly from the line A.

### Main Experiment

### Example 1

A battery was fabricated in the same manner as described in the just-described embodiment.

The battery fabricated in this manner is hereinafter referred to as a battery A1.

### Examples 2 to 6

Batteries were fabricated in the same manner as described in Example 1 above, except that a Cu—Zr alloy foil was used as the substrate of the negative electrode current collector, and that the respective negative electrode current collectors had a surface layer thickness of 1.3 μm and a surface layer voidage of 40%, a surface layer thickness of 2.0 μm and a surface layer voidage of 33%, a surface layer thickness of 2.8 μm and a surface layer voidage of 30%, a surface layer thickness of 3.5 μm and a surface layer voidage of 38%, and a surface layer thickness of 3.9 μm and a surface layer voidage of 32%. The thickness and voidage of the surface layer can be controlled by adjusting the plating time and the current density, for example. This also applies to the following Examples 7 and 8 as well as Comparative Examples 2, 4, 7, and 10.

The batteries fabricated in these manners are hereinafter referred to as batteries A2 to A6, respectively.

### Example 7

A battery was fabricated in the same manner as described in Example 1 above, except that a Cu—Cr—Zr alloy foil was used as the substrate of the negative electrode current collector, and that the surface layer had a thickness of 2.8 μm and a voidage of 30%.

The battery fabricated in this manner is hereinafter referred to as a battery A7.

### Example 8

A battery was fabricated in the same manner as described in Example 1 above, except that a Corson alloy foil was used as the substrate of the negative electrode current collector, and that the surface layer had a thickness of 3.9 μm and a voidage of 32%.

The battery fabricated in this manner is hereinafter referred to as a battery A8.

### Comparative Example 1

A battery was fabricated in the same manner as described in Example 1 above, except that an electrolytic copper foil was used as the substrate of the negative electrode current collector, and that no surface layer was provided.

The battery fabricated in this manner is hereinafter referred to as a battery Z1.

### Comparative Example 2

A battery was fabricated in the same manner as described in Comparative Example 1 above, except that a surface layer made of pure copper and having a thickness of 2.0 μm and a voidage of 33% was formed on each of both sides of the substrate by electroplating.

The battery fabricated in this manner is hereinafter referred to as a battery Z2.

### Comparative Example 3

A battery was fabricated in the same manner as described in Example 1 above, except that a Cu—Sn alloy foil was used as the substrate of the negative electrode current collector, and that no surface layer was provided.

The battery fabricated in this manner is hereinafter referred to as a battery Z3.

### Comparative Example 4

A battery was fabricated in the same manner as described in Comparative Example 3 above, except that a surface layer made of pure copper and having a thickness of 1.0 μm and a voidage of 33% was formed on each of both sides of the substrate by electroplating.

The battery fabricated in this manner is hereinafter referred to as a battery Z4.

### Comparative Example 5

A battery was fabricated in the same manner as described in Example 1 above, except that no surface layer was formed on either side of the substrate.

The battery fabricated in this manner is hereinafter referred to as a battery Z5.

### Comparative Example 6

A battery was fabricated in the same manner as described in Example 2 above, except that no surface layer was formed on either side of the substrate.

The battery fabricated in this manner is hereinafter referred to as a battery Z6.

### Comparative Example 7

A battery was fabricated in the same manner as described in Example 2 above, except that the surface layer had a thickness of 0.7 μm and a voidage of 36%.

The battery fabricated in this manner is hereinafter referred to as a battery Z7.

### Comparative Example 8

A battery was fabricated in the same manner as described in Example 7 above, except that no surface layer was formed on either side of the substrate.

The battery fabricated in this manner is hereinafter referred to as a battery Z8.

### Comparative Example 9

A battery was fabricated in the same manner as described in Example 8 above, except that no surface layer was formed on either side of the substrate.

The battery fabricated in this manner is hereinafter referred to as a battery Z9.

### Comparative Example 10

A battery was fabricated in the same manner as described in Example 8 above, except that the surface layer had a thickness of 2.8 μm and a voidage of 30%.

The battery fabricated in this manner is hereinafter referred to as a battery Z10.

### Experiment 1

For each of the negative electrode plates used in the batteries A1 to A8 and Z1 to Z10, the proof stress and the Vickers hardness of the portion of the negative electrode plate from which the negative electrode current collector was exposed were measured. The results are shown in Table 2 below.

### Experiment 2

The batteries A1 to A8 and Z1 to Z10 were charged and discharged under the following conditions to determine the capacity retention ratio obtained by the following equation (2). The results are also shown in Table 2 below.

Capacity retention ratio(%)=(Discharge capacity at the 51st cycle)/(Initial discharge capacity) (2)

### —Charge-Discharge Conditions for the First Cycle

Each of the batteries was charged at a constant current of 45 mA for 4 hours and thereafter charged at a constant current of 180 mA until the battery voltage reached 4.2 V. Next, each of the batteries was charged at a constant voltage of 4.2 V until the current value reached 45 mA, so that initial charging was carried out for each of the batteries.

Next, each of the batteries that had been subjected to the initial charging was discharged at a constant current of 180 mA until the battery voltage reached 2.75 V (initial discharging). At the time of this discharging, the initial discharge capacity was obtained for each of the batteries.

### —Charge-Discharge Conditions for the Second Cycle to the 51st Cycle

Each of the batteries that had been subjected to the initial charge-discharge was charged at a constant current of 900 mA until the battery voltage reached 4.2 V and thereafter charged at a constant voltage of 4.2 V until the current value reached 45 mA. Next, each of the batteries was discharged at a constant current of 900 mA until the battery voltage reached 2.75 V. This charge-discharge cycle was repeated 50 times. At the time of the discharging in the last charge-discharge cycle, the discharge capacity at the 51st cycle was obtained for each of the batteries.

### Experiment 3

A cross-sectional observation was carried out using CT for each of the batteries that were charged and discharged repeatedly in the just-described experiment 1, to confirm whether or not bending occurred in the spirally-wound electrode assembly. The sample that had bending was determined as a defective product, and the percentage of defective products was determined. The results are also shown in Table 2 below. The number of the samples was 20 for each of the batteries.

TABLE 2

| | | | | | | | Capacity | |
|---|---|---|---|---|---|---|---|---|
| | | Surface layer | | | | Proof | retention | Deformation |
| | | Surface | Thickness | Voidage | Vickers | stress | ratio | defect |
| Battery | Substrate | layer | (μm) | (%) | hardness | (MPa) | (%) | (%) |
| Z1 | Electrolytic | No | — | — | 88 | 185 | 89.6 | 100 |
| Z2 | copper | Yes | 2.0 | 33 | 77 | | 90.1 | 100 |
| | foil | | | | | | | |
| Z3 | Cu—Sn | No | — | — | 117 | 285 | 89 | 50 |
| Z4 | alloy foil | Yes | 2.0 | 33 | 103 | | 89.8 | 50 |
| Z5 | Cu—Fe—P | No | — | — | 127 | 308 | 86.3 | 0 |
| A1 | alloy foil | Yes | 1.0 | 30 | 120 | | 90.6 | 0 |
| Z6 | Cu—Zr | No | — | — | 133 | 385 | 83.3 | 0 |
| Z7 | alloy foil | Yes | 0.7 | 36 | 125 | | 86.6 | 0 |
| A2 | | | 1.3 | 40 | 120 | | 90 | 0 |
| A3 | | | 2.0 | 33 | 113 | | 90.2 | 0 |
| A4 | | | 2.8 | 30 | 97 | | 91 | 0 |
| A5 | | | 3.5 | 38 | 79 | | 91 | 0 |
| A6 | | | 3.9 | 32 | 70 | | 91.2 | 0 |
| Z8 | Cu—Cr—Zr | No | — | — | 160 | 414 | 75.1 | 0 |
| A7 | alloy foil | Yes | 2.8 | 30 | 111 | | 90.2 | 0 |
| Z9 | Corson | No | — | — | 226 | 494 | 74.7 | 0 |
| Z10 | alloy foil | Yes | 2.8 | 30 | 141 | | 82.1 | 0 |
| A8 | | | 3.9 | 32 | 120 | | 88.9 | 0 |

Note:
All the substrates had a voidage of 0%.

As clearly seen from Table 2, the batteries A1 to A8 and the batteries Z1 to Z4, in which the negative electrode current collector surface had a Vickers hardness of 120 or less, exhibited high capacity retention ratios, from 88.9% to 91.2%. On the other hand, the batteries Z5 to Z9, in which the negative electrode current collector surface had a Vickers hardness of higher than 120, showed lower capacity retention ratios, from 74.7 to 86.6%. From the results, it is understood that the cycle performance is improved when the negative electrode current collector surface has a Vickers hardness of 120 or less.

The reason is as follows. When the Vickers hardness is low, the surface shape of the negative electrode current collector easily deforms into the shape of the negative electrode active material particles. Therefore, when pressing the negative electrode current collector after coating the negative electrode active material thereon, the surface of the negative electrode current collector deforms along the shape of the negative electrode active material, allowing the negative electrode current collector and the negative electrode active material to make contact with each other in a sufficient area. As a result, even if stress occurs because of the volume change of the negative electrode active material in association with charging and discharging, the negative electrode active material can be prevented from peeling from the negative electrode current collector.

Moreover, deformation defects of the negative electrode current collector occurred in the batteries Z1 to Z4, in which the negative electrode current collector had a proof stress of less than 300 MPa. In contrast, no deformation defect occurred in the batteries A1 to A8 and the batteries Z5 to Z9, in which the negative electrode current collector had a proof stress of 300 MPa or greater. These results indicate that the deformation of the negative electrode plate resulting from the volume change of the negative electrode active material in association with charging and discharging can be inhibited by controlling the proof stress of the negative electrode current collector to 300 MPa or greater.

As clearly seen from the results for the batteries Z1, Z3, Z5, Z6, and Z8, in which the negative electrode current collector had no surface layer, the material having a greater proof stress showed a greater Vickers hardness accordingly. This indicates that it is difficult to control the proof stress to 300 MPa or greater and the Vickers hardness to 120 or less with the negative electrode current collector having no surface layer (as already discussed in the foregoing preliminary experiment). In contrast, each of the batteries A1 to A8, in which the negative electrode current collector had a surface layer, exhibited a proof stress of 300 MPa or greater and also a Vickers hardness of 120 or less. This makes it possible to inhibit the deformation defects and at the same time ensure a sufficient capacity retention ratio.

Here, it is observed that the proof stress of the negative electrode current collector is determined by the material of the substrate. (For example, in the case where the substrate of the negative electrode current collector is an electrolytic copper foil, both the battery Z1 without the surface layer and the battery Z2 with the surface layer show the same proof stress, 185 MPa. This also applies to the other batteries, as is clearly from Table 2.)

On the other hand, it is also observed that the Vickers hardness is related to the thickness and voidage of the surface layer. First, the voidage of the surface layer is discussed. When comparing the battery Z1, in which the negative electrode current collector has the substrate (electrolytic copper foil) alone, and the battery Z2, in which the surface layer made of the same material as that of the substrate is formed on each of both sides of the substrate (electrolytic copper foil), with each other, the Vickers hardness of the surface layer is less in the battery Z2 than in the battery Z1. The negative electrode current collectors of the battery Z1 and the battery Z2 are different in terms of the presence or absence of the surface layer. However, because their surface layer is made of the same material as that of the substrate, it may appear that the surface layer does not influence the Vickers hardness. Nevertheless, although the surface layer and the substrate are made of the same material, their voidage is different. More specifically, the voidage of the surface layer is 30%, while the voidage of the substrate is 0%. Thus, it is believed that the Vickers hardness varied because of the difference in the voidage of the negative electrode current collector surface. It should be noted that the voidage of the surface layer of the negative electrode current collector was set at 30% or greater in all the batteries in which the surface layer was formed (the batteries A1 to A8, Z4, Z7, and Z10), in addition to the negative electrode current collector used in the battery Z2. The reason is that the Vickers hardness can be easily lowered by controlling the voidage of the surface layer to 30% or greater.

In addition to increasing the voidage of the surface layer, the Vickers hardness can be lowered also by increasing the thickness of the surface layer. When comparing the batteries A2 to A6 and Z7 to each other, it is observed that when the thickness of the surface layer is set greater, the Vickers hardness is lowered. This is also clear from the fact that, even when the voidage is low, the Vickers hardness is greater when the thickness is greater. (For example, compare the battery A3 with the battery A4.) However, in order to lower the Vickers hardness, it is preferable that the voidage of the surface layer be increased as high as possible, and only when the Vickers hardness cannot be lowered, the thickness of the surface layer be increased. The reason is as follows. When the thickness of the surface layer is increased, the thickness of the negative electrode current collector becomes greater accordingly, and it becomes necessary to reduce the thickness of the negative electrode mixture layer correspondingly. Consequently, the filling density of the negative electrode active material per unit volume decreases. In addition, in order to increase the thickness of the surface layer, the plating time should be made longer, for example, which may require an increase in the manufacturing cost.

Furthermore, when the negative electrode current collector has a greater proof, stress, it becomes more difficult to lower the Vickers hardness. This is clear from a comparison between the batteries A4, A7, and Z10. In all the batteries, the thickness of the surface layer is 2.8 μm and the voidage of the surface layer is 30%. Nevertheless, the battery A4, in which the negative electrode current collector has a proof stress of 385 MPa, shows a Vickers hardness of 97; the battery A7, in which the negative electrode current collector has a proof stress of 414 MPa, shows a Vickers hardness of 111; and the battery Z10, in which the negative electrode current collector has a proof stress of 496 MPa, shows a Vickers hardness of 141. Therefore, when the proof stress of the negative electrode current collector becomes great, it is necessary to reduce the Vickers hardness by reducing the voidage of the surface layer or increasing the thickness of the surface layer.

### Other Embodiments

(1) The copper alloy foil usable for the substrate is not limited to the one described above. The copper alloy may be an alloy of copper and at least one metal selected from the group consisting of tin, iron, phosphorus, zirconium, chromium, nickel, silicon, magnesium, cobalt, zinc, silver, beryllium, manganese, and aluminum. Examples include the copper alloy foils shown in Table 3 below.

TABLE 3

Cu—Sn alloy foil
Cu—Fe—P alloy foil
Cu—Zr alloy foil
Cu—Cr—Zr alloy foil
Cu—Ni—Si—Mg alloy foil (Corson alloy foil)
Cu—Ag alloy foil
Cu—Cr alloy foil
Cu—Ti alloy foil
Cu—Be—Co—Ni—Fe alloy foil
Cu—Al—Mn—Fe alloy foil
Cu—Ni—Fe—Mn—Zn alloy foil
Cu—Ni—Si alloy foil

(2) Table 4 below shows the Mohs hardness of various materials that may be used as the battery materials. Of these materials, the materials capable of alloying with lithium are silicon (having a Mohs hardness of 7) and germanium (having a Mohs hardness of 6.5). Therefore, the materials that can be used for the surface layer of the negative electrode current collector may be the materials shown in Table 5. Among these materials, it is preferable to use copper, nickel, and gold, which have low Mohs hardness. Particularly preferable are copper and gold, which show high electrical conductivity. From the viewpoint of cost, it is more preferable to use copper.

TABLE 4

| Material | Mohs hardness |
|---|---|
| Silicon | 7 |
| Graphite | 1-2 |
| Diamond | 10 |
| Germanium | 6.5 |
| Lead | 1.5 |
| Zinc | 2.5 |
| Magnesium | 2.6 |

TABLE 5

| Material | Mohs hardness |
|---|---|
| Copper | 3 |
| Nickel | 3.8 |
| Cobalt | 5.6 |
| Iron | 4.5 |
| Titanium | 4 |
| Gold | 2.5-3 |

(3) The linear pressure in pressing the negative electrode after coating the negative electrode mixture slurry on the negative electrode current collector is not limited to 1.0 tonf/cm as in the foregoing examples. However, it is desirable that the pressure be within the range of from 0.5 tonf/cm to 3.0 tonf/cm. The reason is as follows. If the pressure is less than 0.5 tonf/cm, the negative electrode active material does not sink into the negative electrode current collector sufficiently, so the contact area between the negative electrode active material and the negative electrode current collector becomes small. On the other hand, if the pressure exceeds 3.0 tonf/cm, the deformation of the current collector surface reaches its limit, and the stress on the negative electrode active material particles becomes great. As a consequence, the negative electrode active material particles may be broken.

(4) The surface layer may be formed by other techniques than the electroplating, such as non-electrolytic plating, evaporation, sputtering, and CVD. However, electroplating is desirable from the viewpoint of productivity.

The present invention is expected to be applicable to the power sources for mobile information terminals such as mobile telephones, notebook computers, and PDAs, as well as the power sources for the applications that require high power, such as HEVs and power tools.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A lithium secondary battery comprising:
a positive electrode, a separator, and a negative electrode having a negative electrode current collector and a negative electrode mixture layer formed on a surface of the negative electrode current collector, the negative electrode mixture layer containing a negative electrode active material comprising a metal element capable of alloying with lithium, wherein:
the negative electrode current collector comprises a foil substrate and a surface layer provided on at least one surface of both surfaces of the substrate on which the negative electrode mixture layer is formed; the surface layer has a Vickers hardness of 120 or less and less than that of the substrate; and the negative electrode current collector has a proof stress of 300 MPa or greater.

2. The lithium secondary battery according to claim 1, wherein the substrate of the negative electrode current collector comprises a copper alloy, and the surface layer of the negative electrode current collector comprises pure copper.

3. The lithium secondary battery according to claim 1, wherein the surface layer of the negative electrode current collector has a voidage of 30% or greater.

4. The lithium secondary battery according to claim 1, wherein the surface layer of the negative electrode current collector has a Mohs hardness lower than that of the negative electrode active material.

5. The lithium secondary battery according to claim 4, wherein the negative electrode active material contains silicon as its main component.
